(19) United States
(12) Patent Application Publication
(10) Pub. No.: US 2013/0280406 A1
(43) Pub. Date: Oct. 24, 2013

(54) METHOD FOR SUPPRESSING BITTERNESS

(71) Applicant: Koji Hanaoka, Utsunomiya-shi (JP)

(72) Inventor: Koji Hanaoka, Utsunomiya-shi (JP)

(73) Assignee: KAO CORPORATION, Chuo-ku (JP)

(21) Appl. No.: 13/996,943

(22) PCT Filed: Dec. 21, 2011
(86) PCT No.: PCT/JP2011/079690

§ 371 Date: Jun. 21, 2013

(30) Foreign Application Priority Data
Dec. 22, 2010 (JP) 2010285345

(51) Int. Cl. A23F 3/40

(52) U.S. Cl. CPC A23F 3/405
USPC 426/597; 426/661; 426/590

(57) ABSTRACT

Provided is a method for suppressing bitterness capable of effectively suppressing unpleasant bitterness. The method for suppressing bitterness according to the present invention comprises incorporating amylopectin in a composition having bitterness.

### FIELD OF THE INVENTION

The present invention relates to a method for suppressing bitterness.

### BACKGROUND OF THE INVENTION

Bitter food and drinks are known, for example, drinks such as coffee and green tea, beans such as soybeans and azuki beans, vegetables such as bell peppers, and citrus such as grapefruits. These food and drinks comprise, for example, flavonoids such as catechin and naringin, caffeine, saponin, or limonin as a bitter component.

It should be pointed out that bitterness is one type of taste, and while a slight hint of bitterness is effective in enhancing the preference, an overly strong bitterness taste may cause an unpleasant feeling or a disgusting feeling.

As a means for suppressing such unpleasant bitterness, for example, a method of adding protamine and/or a salt thereof (Patent Document 1), a method of adding a certain amount of sugar alcohols (Patent Documents 2 and 3), a method of adding a certain amount of cyclodextrin (Patent Document 4), a method of adding sugarcane-derived extracts (Patent Document 5), and a method of incorporating cereal-derived starch (Patent Document 6) have been proposed.

### CITATION LIST

### Patent Document

[Patent Document 1] JP-A-6-153875
[Patent Document 2] JP-A-7-274829
[Patent Document 3] JP-A-11-253102
[Patent Document 4] JP-A-10-4919
[Patent Document 5] JP-A-2002-34471
[Patent Document 6] JP-A-2010-193831

### SUMMARY OF THE INVENTION

The present invention provides a method for suppressing bitterness, comprising incorporating amylopectin in a composition having bitterness.

The present invention further provides a drink comprising the following components (A), (B), and (C);

(A) a bitter component,
(B) from 0.15 to 0.9% by mass of amylopectin, and
(C) from 0.0001 to 0.05% by mass of amylose.

### EMBODIMENT FOR CARRYING OUT THE INVENTION

Recently, along with diversification of consumers' preferences and an increase in health consciousness, development of a bitterness suppression agent which is a naturally derived component capable of effectively suppressing unpleasant bitterness has been in demand. Further, there have been cases in which the mere incorporation of a small amount of protamine, sugar alcohols, cyclodextrin, sugarcane-derived extracts, or starch in food and drinks and the like having a bitterness as described in the aforementioned conventional art resulted in an insufficient bitterness suppressing effect. Also, there have been cases in which when the amount of incorporation was increased with an aim to enhance the bitterness suppressing effect, the original texture and taste and flavor of the food and drinks and the like were impaired.

The present invention provides a method for suppressing bitterness which can effectively suppress unpleasant bitterness. Also, the present invention provides a drink in which thickening and unpleasant bitterness are effectively suppressed without affecting the taste and flavor.

Cyclodextrin, which is known as a bitterness suppression agent, is a polysaccharide. For example, when a large amount of cyclodextrin is added to food and drinks, the taste and flavor might be impaired, and in the case of drinks, they might thicken due to an increase in viscosity, possibly generating a sense of discomfort with the original texture of the drinks such as the feel on the palate and the feeling during swallowing. The present inventors searched for a naturally-derived component capable of effectively suppressing unpleasant bitterness without impairing the original texture of food and drinks. As a result, surprisingly, they found that, among those polysaccharides which have larger molecular weights than cyclodextrin, a fraction of starch having a branched structure can effectively suppress unpleasant bitterness without impairing the texture of food and drinks.

The present invention can effectively suppress unpleasant bitterness. Also, in the drinks of the present invention, thickening and unpleasant bitterness can be effectively suppressed without affecting the taste and flavor.

### (Bitterness Suppression Agent and Method for Suppressing Bitterness)

The bitterness suppression agent of the present invention comprises amylopectin as an active component. Also, the method for suppressing bitterness according to the present invention comprises incorporating amylopectin in a composition having bitterness. Here, the term “amylopectin” refers to one of polysaccharides, which is a branched polymer in which branching takes place by α-1,6 glycosidic linkage in the main chain made up of glucose units polymerized through α-1,4 glycosidic linkage. Amylopectin is a component of starch, and starch is a mixture of amylopectin and amylose. Here, the term “amylose” refers to a linear polymer of glucose units polymerized primarily through α-1,4 glycosidic linkage.

Amylopectin may be obtained by extracting starch from plants comprising amylopectin. Examples of the extraction method include a publicly known method such as a method of extraction with water, an organic solvent, or an aqueous solution of an organic solvent and a method of supercritical extraction. Also, the extract thus obtained may be separated into the starch fraction and protein fraction based on the difference in specific gravity by, for example, centrifugation, and then collected. Furthermore, starch may also be collected by enzymatically degrading proteins in the extract. It is noted that examples of the organic solvent used for extraction include alcohols such as ethanol, ketones such as acetone, esters such as ethyl acetate. One of these organic solvents or a combination of two or more of them may be used.

Examples of the plant used for extraction include rice such as glutinous rice and non-glutinous rice, cereal crops such as barley and wheat, corns such as dent corn, flint corn, popcorn, and waxy corn, root crops such as potato and sweet potato, and beans such as soybean and pea. One of these plants or a combination of two or more of them may be used.

Here, the content ratio of amylopectin and amylose in starch varies depending on the kind of plant in which starch is reserved. Also, even among the plants of the same species, the amounts of amylopectin and amylose greatly vary from one tissue to another, such as leaves, stems, roots, and seeds, all of which are starch-producing organs. Furthermore, there is a slight variation in the form and taste of starch and the physical properties of gelatinized starch, depending on the origin of starch, such as rice, root crops, cereal crops, and corn.

From the viewpoint of bitterness suppression and texture, starch which comprises a high proportion of amylopectin and is easily gelatinized is preferably used in the present invention. Specifically, starch having an amylopectin (active component) content of 90% by mass or more is preferably used, starch having an amylopectin content of 93% by mass or more is more preferably used, and starch having an amylopectin content of 95% by mass or more is even more preferably used as a bitterness suppression agent. It is noted that no particular limitation is imposed on the upper limit of the amylopectin content in starch, and it may be 100% by mass; however, from the standpoint of industrial productivity, the content is preferably 98% by mass, more preferably 96% by mass. The amylopectin content in starch ranges from preferably 90 to 98% by mass, more preferably from 93 to 98% by mass, more preferably from 95 to 98% by mass, and even more preferably from 95 to 96% by mass.

As the above-described starch, starch derived from at least one selected from glutinous rice and waxy corn is preferable. For example, such starch can be easily obtained by extracting from glutinous rice, waxy corn, and the like. Further, it may be also possible to add commercially available amylopectin to plant-derived starch other than those described above so as to adjust the content ratio of amylopectin to the total amount of starch within the range specified above, and use the resulting starch.

The form of the bitterness suppression agent of the present invention maybe appropriately selected according to the conditions of use. Examples of the form include various forms such as a solid, a liquid, a solution, and a slurry.

The bitterness suppression agent of the present invention may be applied to any substance without any particular limitation as long as the substance comprises a bitter component. It is preferably applied to a composition having a bitterness intensity of 7 or less based on the quinine sulfate standard solution. The “bitterness intensity based on the quinine sulfate standard solution” as used in the present specification refers to, in a sensory test based on 10 standard solutions each adjusted in advance to have different levels of bitterness intensity which differ by equal increments using quinine sulfate (refer to Table 1 of Example, Indow, T, Perception & Psychophysics, Vol. 5 (1969), pp. 347 to 351), the bitterness intensity of the quinine sulfate standard solution which was recognized by a subject, among those standard solutions, to have an equal bitterness intensity to the test substance. Specifically, the bitterness intensity is determined by the following procedure. Firstly, five healthy people having a normal sense of taste are assigned to be subjects, and each subject holds each quinine sulfate standard solution in the mouth in ascending order of the concentration to memorize the bitterness intensity thereof. Subsequently, each subject holds a test substance in the mouth to recognize the degree of bitterness, and from among the quinine sulfate standard solutions, determines one having the closest bitterness level. Then, the numerical values of bitterness intensity determined by each subject are averaged out, and provided as the bitterness intensity of the test substance. It is noted that the smaller the bitterness intensity, the weaker the bitterness.

The bitterness intensity applied to the bitterness suppression agent of the present invention is preferably 7 or less, more preferably 6 or less based on the quinine sulfate standard solution. Also, although no particular limitation is imposed on the lower limit of the bitterness intensity, it is preferably 3, more preferably 4 based on the quinine sulfate standard solution. The bitterness intensity preferably ranges from 3 to 7, more preferably from 3 to 6, and even more preferably from 4 to 6.

Examples of such a composition having bitterness include oral pharmaceutical products, oral quasi drugs, food and drinks and the like, which are bitter.

Examples of the bitter component in an oral pharmaceutical product include strychnine, quinine, papaverine, berberine, promethazine, brucine, propranolol, and chlorpromazine and the like. These medicaments may be in the form of acid addition salts, and examples thereof include mineral acid salts such as hydrochlorides, nitrates, sulfates, and carbonates, and organic acid salts such as acetates and citrates.

Examples of the oral quasi drug include tooth pastes, mouthwash, and mouth rinse and the like. Examples of the bitter component in an oral quasi drug include surfactants such as sodium alkyl sulfate and sodium monoalkyl phosphate, fragrances such as menthol, linalool, phenyl ethyl alcohol, and geraniol, and antimicrobial agents such as methylparaben and propylparaben. It is noted that no particular limitation is imposed on the dosage form of the oral pharmaceutical product and the oral quasi drug, and a known dosage form may be adopted.

Also, examples of the food and drink having bitterness include citrus fruits such as grapefruits, oranges, and lemons or fruit juice obtained from these fruits; vegetables such as tomatoes, bell peppers, celeries, gourds, carrots, potatoes, and asparaguses or vegetable extracts or vegetable juice obtained from these vegetables; seasonings such as sauce, soy sauce, miso (i.e., Japanese fermented soybean paste), chili pepper, and flavor enhancer for savoriness; soy food such as soy milk; emulsified food such as cream, dressings, mayonnaise, and margarine; processed seafood products such as fish meat, minced fish, and fish eggs; nuts such as peanut; fermented food such as natto (i.e., fermented soybeans); edible meat or processed meat products; drinks such as tea including green tea, black tea and oolong tea and the like, beer, coffee, cocoa, soft drinks, and functional drinks; pickled foods; noodles; soups including powder soup; dairy products such as cheese and milk; bread and cakes; and confectionery such as snacks, biscuits, snacks made from rice, chewing gum, chocolate, and candies.

Examples of the (A) bitter component in these food and drinks include amino acids, peptides, terpenes, polyphenols, caffeine, and oligosaccharides. Here, the term “polyphenols” as used in the present specification refers to those which are measured by the ferrous tartrate method. Specific examples thereof include flavonoids such as flavones, flavonols, isoflavones, flavans, flavanols, flavanones, flavanonols, chalcones, and anthocyanidins, glycosides and polymers of these flavonoids, chlorogenic acids, gallic acid, coumarins, curcumins, and lignans. Examples of the flavones include apiin, apigenin, orientin, and isoorientin. Examples of the flavonols include quercetin, myricetin, kaempferol, and rutin. Examples of the glycosides of flavanones include naringin. Examples of the flavanols include the non-polymer catechins, and examples of the polymer of flavanols include proanthocyanidin and tannin. Examples of the amino acids include leucine, isoleucine, and phenylalanine. Examples of the terpenes include saponin and limonin.

The amount of amylopectin to be used may be appropriately selected depending on the kind of bitter component and the bitterness intensity. However, from the viewpoint of suppression of bitterness, the amount of amylopectin to be used is preferably 0.15% by mass or more, more preferably 0.2% by mass or more, more preferably 0.25% by mass or more, more preferably 0.3% by mass or more, more 0.35% by mass or more, and even more preferably 0.4% by mass or more relative to the total mass of the composition having bitterness. Meanwhile, in order not to affect the taste and flavor and the like, the upper limit is preferably 2% by mass, more preferably 1.5% by mass, more preferably 1.2% by mass, more preferably 1% by mass, more preferably 0.9% by mass, more preferably 0.8% by mass, more preferably 0.75% by mass, more preferably 0.7% by mass, more preferably 0.6% by mass, and even more preferably 0.5% by mass relative to the total mass of the composition having bitterness. The amount of amylopectin to be used ranges preferably from 0.15 to 2% by mass, more preferably from 0.15 to 0.9% by mass, more preferably from 0.25 to 0.9% by mass, more preferably from 0.3 to 0.8% by mass, more preferably from 0.3 to 0.75% by mass, and even more preferably from 0.3 to 0.5% by mass.

Also, from the viewpoint of suppression of bitterness, a composition having a bitterness intensity of 7 or less is preferable, a composition having a bitterness intensity of 6 or less is more preferable, and a composition having a bitterness intensity of from 3 to 6 is even more preferable based on the quinine sulfate standard solution.

### (Drink)

The drink of the present invention comprises the aforementioned (A) bitter component, (B) from 0.15 to 0.9% by mass of amylopectin, and (C) from 0.0001 to 0.05% by mass of amylose.

The content of (B) amylopectin in the drink is 0.15% by mass or more, and from the viewpoint of the bitterness suppressing effect, the content is preferably 0.2% by mass or more, more preferably 0.25% by mass or more, more preferably 0.3% by mass or more, more preferably 0.35% by mass or more, and even more preferably 0.4% by mass or more. Although the upper limit of the content of (B) amylopectin is 0.9% by mass, in order to prevent thickening of the drink, the upper limit is preferably 0.8% by mass, more preferably 0.75% by mass, more preferably 0.7% by mass, more preferably 0.6% by mass, and even more preferably 0.5% by mass. The content of (B) amylopectin ranges preferably from 0.15 to 0.9% by mass, more preferably from 0.2 to 0.8% by mass, more preferably from 0.25 to 0.75% by mass, more preferably from 0.3 to 0.7% by mass, more preferably from 0.35 to 0.6% by mass, and even more preferably from 0.4 to 0.5% by mass.

Also, although the content of (C) amylose in the drink is 0.05% by mass or less, in order to prevent thickening of the drink, the content is preferably 0.04% by mass or less, more preferably 0.035% by mass or less, and even more preferably 0.02% by mass or less. Although the lower limit of the content of (C) amylose in the drink is 0.0001% by mass, from the standpoint of industrial productivity, the lower limit is preferably 0.001% by mass, more preferably 0.005% by mass, and even more preferably 0.01% by mass. The content of (C) amylose ranges preferably from 0.001 to 0.04% by mass, more preferably from 0.005 to 0.035% by mass, more preferably from 0.01 to 0.035% by mass, and even more preferably from 0.01 to 0.02% by mass.

In order to adjust the content of amylose in the drink of the present invention within the range specified above, starch comprising a high proportion of amylopectin is preferably used. Specifically, starch having an amylopectin content of 90% by mass or more is preferably used, starch having an amylopectin content of 93% by mass or more is more preferably used, and starch having an amylopectin content of 95% by mass or more is even more preferably used. It is noted that no particular limitation is imposed on the upper limit of the amylopectin content in starch, and it may be 100% by mass; however, from the standpoint of industrial productivity, the content is preferably 98% by mass, more preferably 96% by mass. Starch may be derived from materials mentioned in connection with the bitterness suppression agent above. The amylopectin content in starch ranges preferably from 90 to 98% by mass, more preferably from 93 to 98% by mass, more preferably from 95 to 98% by mass, and even more preferably from 95 to 96% by mass.

Examples of the bitter component in the drink of the present invention include those listed as the bitter component of food and drinks above. The bitterness intensity of the drink of the present invention is preferably 7 or less, more preferably 6 or less, based on the quinine sulfate standard solution in view of effective suppression of bitterness. The bitterness intensity ranges preferably from 3 to 7, more preferably from 3 to 6, and even more preferably from 4 to 6. From the above viewpoint, the aforementioned bitter component is preferably a bitter component derived from tea, and among such bitter components, polyphenols are preferable, and further, flavonoids are more preferable, and the non-polymer catechins are even more preferable.

Further, the content of the bitter component in the drink is preferably an amount such that the bitterness intensity of the drink is 7 or less, more preferably an amount such that the bitterness intensity of the drink is 6 or less, based on the quinine sulfate standard solution. The bitterness intensity ranges preferably from 3 to 7, more preferably from 3 to 6, and even more preferably from 4 to 6.

When the non-polymer catechins are comprised as a bitter component, the content of the non-polymer catechins in the drink is preferably from 0.03 to 0.6% by mass, more preferably from 0.05 to 0.4% by mass, and even more preferably from 0.1 to 0.2% by mass in view of effective suppression of bitterness. Here, the “non-polymer catechins” as used in the present specification is a generic term collectively referring to a non-epi-form catechin which includes catechin, gallocatechin, catechin gallate, and gallocatechin gallate, and epi-form catechin which includes epicatechin, epigallocatechin, epicatechin gallate, and epigallocatechin gallate. The present invention may comprise at least one of them. It should be noted that the content of the non-polymer catechins is defined based on the sum of the aforementioned eight non-polymer catechins.

The drink comprising the non-polymer catechins as a bitter component may be produced by, for example, mixing at least one selected from a tea extract solution, a catechin preparation, and a purified catechin preparation with plant-derived starch, and adjusting the concentration of each of the (A) non-polymer catechins, (B) amylopectin, and (C) amylose. Examples of the “tea extract solution” include an extract solution which is obtained from tea leaves using hot water or a water-soluble organic solvent by kneader extraction, column extraction, and the like, in which the extract solution has not been subjected to a concentration or purification operation. Tea leaves can be roughly classified into unfermented tea, semi-fermented tea, and fermented tea, depending on the processing method applied. Examples of the unfermented tea include green tea such as sencha, bancha, tencha, kamairicha, kukicha, bocha, and mecha. Examples of the semi-fermented tea include oolong tea such as tekkannon, shikishu, ogonkei, and buigancha. Further, examples of the fermented tea include black tea such as Darjeeling, Assam, and Sri Lanka. One of these teas or a combination of two or more of them may be used. Also, examples of the catechin preparation include a concentration having a higher concentration of the non-polymer catechins, which is obtained by removing a part of the solvent from the extract solution, and a solution comprising the non-polymer catechins which has been treated with an enzyme having a tannase activity by the methods described in, for example, JP-A-2007-282568, JP-A-2006-160656, JP-A-2008-079609, and JP-A-2004-321105. Also, examples of the form of the catechin preparation include various forms such as a solid, an aqueous solution, and a slurry. Also, a commercial product may be used as the catechin preparation, and examples thereof include “POLYPHENON” supplied by MITSUI NORIN CO., LTD., “THEA-FLAN” supplied by ITO EN, LTD., and “SUNPHENON” supplied by TAIYO KAGAKU CO., LTD. Also, examples of the purified catechin preparation include ones obtained by purifying catechin preparations by the methods described in, for example, JP-A-2004-147508, JP-A-2004-149416, and JP-A-2007-282568.

Among them, from the viewpoint of the bitterness suppressing effect, the present invention maybe preferably used for a packaged drink comprising the purified catechin preparation. From the viewpoint of suppression of bitterness and improvement of storage stability, the purity of (A) the non-polymer catechins in the solid content of the purified catechin preparation is preferably from 45 to 90% by mass, more preferably from 50 to 80% by mass, and even more preferably from 55 to 70% by mass.

Also, additives such as sweeteners, acidulants, carbon dioxide gas, antioxidants, organic acids, organic acid salts, inorganic acids, inorganic acid salts, inorganic salts, colorants, emulsifiers, preservatives, seasonings, gum, oil, vitamins, fruit juice, vegetable extracts, floral nectar essence, pH adjusters, and quality stabilizers may be incorporated singly or in combination of two or more to the drink of the present invention as needed. The content of these additives may be appropriately selected within such a range that does not impair the present invention.

Also, the drink according to the present invention can be provided in a packaging container such as molded containers made of polyethylene terephthalate as a principal component (so-called PET bottle), metal cans, paper containers combined with metal films or plastic films, or glass bottles. Further, after a container is filled therewith, when heat sterilization is feasible, for example when a metal can is used, the drink according to the present invention can be sterilized under the conditions as stipulated in the laws and regulations to be applied (such as the Food Sanitation Act in Japan). Meanwhile, for those for which retort sterilization is not feasible such as PET bottles and paper containers, a process may be adopted such that the drink is sterilized beforehand at a high temperature for a short time under similar sterilization conditions to those described above, for example, by using a plate-type heat exchanger, is cooled to a particular temperature, and is then filled in containers. Also, under an aseptic environment, other components may be added to the drink-filled containers.

Preferable embodiments of the present inventions are as follows.

[1-1] A method for suppressing bitterness, comprising incorporating amylopectin in a composition having bitterness.
[1-2] The method for suppressing bitterness according to the aforementioned [1-1], wherein the bitterness intensity of the composition having a bitterness is preferably 7 or less, preferably from 3 to 7, more preferably from 3 to 6, and even more preferably from 4 to 6 based on the quinine sulfate standard solution.
[1-3] The method for suppressing bitterness according to the aforementioned [1-1] or [1-2], wherein amylopectin is incorporated in an amount of preferably 0.15% by mass or more, more preferably from 0.15 to 2% by mass, more preferably from 0.15 to 0.9% by mass, more preferably from 0.25 to 0.9% by mass, more preferably from 0.3 to 0.8% by mass, more preferably from 0.3 to 0.75% by mass, and even more preferably from 0.3 to 0.5% by mass relative to the total mass of the composition having bitterness.
[1-4] The method for suppressing bitterness according to any one of the aforementioned [1-1] to [1-3], wherein the amylopectin is derived from starch having an amylopectin content of preferably 90% by mass or more, more preferably from 90 to 98% by mass, more preferably from 93 to 98% by mass, preferably from 95 to 98% by mass, and even more preferably from 95 to 96% by mass.
[1-5] The method for suppressing bitterness according to the aforementioned [1-4], wherein the starch is obtained from at least one selected from the group consisting of glutinous rice and waxy corn.
[1-6] The method for suppressing bitterness according to any one of the aforementioned [1-1] to [1-5], wherein the bitter component is derived from tea.
[1-7] The method for suppressing bitterness according to the aforementioned [1-6], wherein the tea is selected from among green tea, black tea, and oolong tea.
[1-8] The method for suppressing bitterness according to any one of the aforementioned [1-1] to [1-7], wherein the bitter component is preferably polyphenols, more preferably flavonoids, and even more preferably the non-polymer catechins.
[2-1] A drink comprising the following components (A), (B), and (C);
(A) a bitter component,
(B) from 0.15 to 0.9% by mass of amylopectin, and
(C) from 0.0001 to 0.05% by mass of amylose.
[2-2] The drink according to the aforementioned [2-1], wherein the content of (B) amylopectin is preferably from 0.2 to 0.8% by mass, more preferably from 0.25 to 0.75% by mass, more preferably from 0.3 to 0.7% by mass, more preferably from 0.35 to 0.6% by mass, and even more preferably from 0.4 to 0.5% by mass.
[2-3] The drink according to the aforementioned [2-1] or
[2-2], wherein the content of (C) amylose is preferably from 0.001 to 0.04% by mass, more preferably from 0.005 to 0.035% by mass, more preferably from 0.01 to 0.035% by mass, and even more preferably from 0.01 to 0.02% by mass.
[2-4] The drink according to any one of the aforementioned [2-1] to [2-3], wherein the (B) amylopectin is derived from starch having an amylopectin content of preferably from 90 to 98% by mass, more preferably from 93 to 98% by mass, more preferably from 95 to 98% by mass, and even more preferably from 95 to 96% by mass.
[2-5] The drink according to any one of the aforementioned [2-1] to [2-4], wherein the (A) bitter component is derived from tea.
[2-6] The drink according to the aforementioned [2-5], wherein the tea is selected from green tea, black tea, and oolong tea.
[2-7] The drink according to any one of the aforementioned [2-1] to [2-6], wherein the (A) bitter component is preferably polyphenols, more preferably flavonoids, and even more preferably the non-polymer catechins.
[2-8] The drink according to any one of the aforementioned [2-1] to [2-7], wherein the content of the (A) bitter component is an amount such that the bitter intensity of the drink is 7 or less, preferably from 3 to 7, more preferably from 3 to 6, and even more preferably from 4 to 6 based on the quinine sulfate standard solution.
[2-9] The drink according to any one of the aforementioned [2-1] to [2-7], wherein the (A) bitter component is the non-polymer catechins, and the content of the (A) non-polymer catechins in the drink is preferably from 0.03 to 0.6% by mass, more preferably from 0.05 to 0.4% by mass, and even more preferably from 0.1 to 0.2% by mass.

### EXAMPLES

### Production Example 1

### Production of Catechin Preparation

Tannase (Tannase KTFH, the product of KIKKOMAN BIOCHEMIFA CORPORATION, 500 U/g) was added to a green tea extract (concentration of the non-polymer catechins of 30% by mass) at a final concentration of 1.1% by mass, and the resulting green tea extract was kept for 55 minutes. The green tea extract was then heated to and kept at 90° C. for two minutes to deactivate the enzyme activity, followed by termination of the reaction (pH 5.2). Subsequently, under the conditions of 70° C. and 6.7 kPa, the green tea extract was subjected to a concentration process until a Brix concentration of 20% was achieved by concentration under reduced pressure. The concentrated green tea extract was then spray-dried, whereby a tannase-treated green tea extract powder was obtained. Subsequently, the non-polymer catechins were extracted from the resulting green tea extract powder with a mixed solvent of ethanol and water (water:ethanol=40:60). Then, a contact treatment was performed by adding 8 parts by mass of activated carbon relative to 100 parts by mass of extract solution. The resulting extract solution was then filtered through a 0.2 μm membrane filter to provide a catechin preparation. The content of the non-polymer catechins in the solid content of the catechin preparation thus obtained was 62.5% by mass.

### Production Example 2

### Production of Glutinous Rice Extract

Polished glutinous rice (20 g) was pulverized by a coffee mill, and extracted with boiling water at a bath ratio of 30-fold. Subsequently, the resulting extract was filtered through a metal mesh with 120 mesh and cooled to 25° C. or below, and then filtered through a No. 2 filter paper to provide a glutinous rice extract. In the glutinous rice extract thus obtained, the content of (B) amylopectin was 1.15% by mass, the total amount of (D) starch was 1.20% by mass, and the content ratio of (B) amylopectin to the total amount of (D) starch, ((B)/(D)×100), was 96% by mass.

### Production Example 3

### Production of Cereal Extract

Into a 2 L container, 20 times the mass of ion-exchanged water at 90° C. to the raw material cereal was placed. Subsequently, to ion-exchanged water which was maintained at a water temperature of 90° C., 50 g of the raw material cereal [95% by mass of roasted barley (the product of MARUBENI FOODS CORPORATION), 2.5% by mass of pulverized Job's Tears (the product of MITSUI NORIN CO., LTD.), and 2.5% by mass of unpolished rice (the product of MARUBENI FOODS CORPORATION)] and 1 g of sodium bicarbonate were added. Then, operation of stirring at 250 rpm for 30 seconds, and then for 30 seconds with 5-minute intervals was carried out for 30 minutes. Subsequently, the resulting extract was roughly filtered through each of the sieves with 20 mesh and 80 mesh, and the filtrate thus obtained was cooled to 25° C. or below. The filtrate was then filtered through a No. 2 filter paper to provide a cereal extract. In the cereal extract thus obtained, the content of (B) amylopectin was 2.78% by mass, the total amount of (D) starch was 3.95% by mass, and the content ratio of (B) amylopectin to the total amount of (D) starch, ((B)/(D)×100), was 70.3% by mass.

### Production Example 4

### Production of Green Tea Extract Solution

Green tea (normal sencha, the product of AIYA JAPAN CORPORATION) (33.7 g) was extracted with 1000 g of ion-exchanged water at 65° C. for five minutes while stirring at 250 rpm. Tea leaves were separated by a metal mesh, and the resulting extract was cooled to 25° C. and subjected to suction filtration using a No. 2 filter paper to provide a green tea extract solution. In the green tea extract solution thus obtained, the content of the non-polymer catechins was 0.270% by mass, and the content of tannin was 0.273% by mass. Also, the content of the non-polymer catechins in the solid content of the green tea extract solution was 28.7% by mass.

### Production Example 5

### Production of Oolong Tea Extract Solution

Oolong tea (Jian'ou oolong tea, first grade, the product of MARUBENI FOODS CORPORATION) (33.7 g) was extracted with 1000 g of ion-exchanged water at 90° C. for five minutes while stirring at 250 rpm. Tea leaves were separated by a metal mesh, and the resulting extract solution was cooled to 25° C. and subjected to suction filtration using a No. 2 filter paper to provide an oolong tea extract solution. In the oolong tea extract solution thus obtained, the content of the non-polymer catechins was 0.129% by mass, and the content of tannin was 0.215% by mass. Also, the content of the non-polymer catechins in the solid content of the oolong tea extract solution was 15.7% by mass.

### Production Example 6

### Production of Black Tea Extract Solution

Black tea (Uva plain BOP, the product of MITSUI NORIN CO., LTD.) (33.7 g) was extracted with 1000 g of ion-exchanged water at 90° C. for 90 seconds while stirring at 250 rpm. Tea leaves were separated by a metal mesh, and the resulting extract solution was cooled to 25° C. and subjected to suction filtration using a No. 2 filter paper to provide a black tea extract solution. In the black tea extract solution thus obtained, the content of the non-polymer catechins was 0.072% by mass and the content of tannin was 0.300% by mass. Also, the content of the non-polymer catechins in the solid content of the black tea extract solution was 5.2% by mass.

### [Measurement of the Non-Polymer Catechins]

A sample solution was filtered through a filter (0.45 μm), and then analyzed by the gradient method using a high performance liquid chromatograph (model SCL-10 AVP, the product of SHIMADZU CORPORATION) equipped with the octadecyl group-introduced packed column for liquid chromatography L-column TM ODS (a diameter of 4.6 mm×250 mm: the product of CHEMICAL EVALUATION AND RESEARCH INSTITUTE, JAPAN) at a column temperature of 35° C. Measurement was performed under the following conditions: liquid A in the mobile phase was a distilled aqueous solution containing 0.1 mol/L of acetic acid, liquid B in the mobile phase was an acetonitrile solution containing 0.1 mol/L of acetic acid, the sample input amount was 20 μL, and the UV detector wavelength was 280 nm.

### [Measurement of Tannin]

Tannin was measured in terms of gallic acid by the ferrous tartrate method using ethyl gallate as a standard solution (reference literature: “Green tea polyphenol”, Technology series for the effective utilization of dietary functional materials, No. 10). Color was developed in 5 mL of the sample with 5 mL of the ferrous tartrate standard solution, and the resulting solution was measured up to 25 mL with phosphate buffer. Subsequently, absorbance was measured at 540 nm, and from the calibration curve prepared using ethyl gallate, tannin was quantitated.

Preparation of the ferrous tartrate standard solution: 100 mg of ferrous sulfate heptahydrate and 500 mg of potassium sodium tartrate were measured up to 100 mL with distilled water.

Preparation of phosphate buffer: a 1/15 mol/L of disodium hydrogen phosphate solution and a 1/15 mol/L of sodium dihydrogen phosphate solution were mixed, and adjusted to pH 7.5.

### [Evaluation of Bitterness Intensity]

Five expert panelists conducted a sensory test with reference to the bitterness level of the test solutions or drinks using the quinine sulfate standard solutions shown in the following Table 1 as a standard, and an average score of the evaluation scores submitted by each panelist was calculated.

TABLE 1
<Quinine sulfate standard solution>

| Bitterness | Concentration of quinine sulfate |
|---|---|
| intensity | (g/100 mL aq.) |
| 1 | 0.00022 |
| 2 | 0.00048 |
| 3 | 0.00090 |
| 4 | 0.00150 |
| 5 | 0.00230 |
| 6 | 0.00370 |
| 7 | 0.00580 |
| 8 | 0.00940 |
| 9 | 0.01500 |
| 10 | 0.02450 |

### [Evaluation of Thickness]

Five expert panelists conducted a sensory test with reference to the thickness of the test solutions or drinks based on the following criteria using ion-exchanged water as a standard, and an average score of the evaluation scores submitted by each panelist was calculated.

1: Same as ion-exchanged water
2: Very slightly thicker than ion-exchanged water
3: Slightly thicker than ion-exchanged water
4: Thicker than ion-exchanged water

### Examples 1 to 4 and Comparative Examples 1 to 4

Amylopectin, amylose, β-cyclodextrin, and cyclic oligosaccharides were incorporated in 0.00370 g/100 mL quinine sulfate standard solutions (Comparative Example 1, bitterness intensity 6) at the ratios as shown in Table 2. The resulting solutions were heated at 100° C. for five minutes and the substances incorporated therein were uniformly dissolved, followed by cooling. The test solutions thus prepared were subjected to a sensory test. It is noted that as amylopectin, commercially available amylopectin (the product of MP BIOMEDICALS) was used. The results thus obtained are shown in Table 2.

TABLE 2

| | | Example | | | | Comparative Example | | | |
|---|---|---|---|---|---|---|---|---|---|
| | | 1 | 2 | 3 | 4 | 1 | 2 | 3 | 4 |
| Formulation | Quinine sulfate | 0.0038 | | | | | | | |
| (% by mass) | dihydrate¹⁾ | | | | | | | | |
| | Amylopectin²⁾ | 0.30 | 0.45 | 0.60 | 0.405 | — | — | — | — |
| | Amylose³⁾ | — | — | — | 0.045 | — | 0.60 | — | — |
| | β-cyclodextrin⁴⁾ | — | — | — | — | — | — | 0.60 | — |
| | Cyclic | — | — | — | — | — | — | — | 0.60 |
| | oligosaccharides⁵⁾ | | | | | | | | |
| | Ion-exchanged | Balance | | | | | | | |
| | water | | | | | | | | |
| | Total | 100 | | | | | | | |
| Amylopectin content | | 100.0 | 100.0 | 100.0 | 90.0 | — | 0.0 | — | — |
| in starch (% by mass) | | | | | | | | | |
| Sensory | Bitterness | 5.5 | 5.5 | 5.0 | 5.5 | 6.0 | 5.8 | 5.8 | 5.8 |
| evaluation | intensity | | | | | | | | |
| | Thickness | 1.0 | 1.0 | 2.0 | 2.4 | 1.0 | 3.0 | 3.6 | 4.0 |

¹⁾Quinine sulfate dihydrate (WAKO PURE CHEMICAL INDUSTRIES, LTD.)
²⁾Amylopectin (MP Biomedicals, amylopectin 100% by mass)
³⁾Amylose (KANTO CHEMICAL CO., INC. amylose 100% by mass)
⁴⁾Celldex B-100 (NIHON SHOKUHIN KAKO CO., LTD.)
⁵⁾Celldex SL-20P (NIHON SHOKUHIN KAKO CO., LTD.)

From Table 2, it was found that unpleasant bitterness was successfully and effectively suppressed by the inclusion of amylopectin. Also, comparing Example 1 to Comparative Examples 3 and 4, it was found that amylopectin was able to sufficiently suppress unpleasant bitterness using a smaller amount compared to the conventional bitterness suppression agents. Further, comparing Example 3 to Comparative Examples 3 and 4, it was found that even when a large amount of amylopectin was added, the test solution did not thicken, and thus the texture was not impaired.

### Examples 5 to 13 and Comparative Examples 5 to 12

The catechin preparation obtained in Production Example 1, the glutinous rice extract obtained in Production Example 2, the cereal extract obtained in Production Example 3, amylose, β-cyclodextrin, and cyclic oligosaccharides were incorporated at the ratios as shown in Table 3. The resulting solutions were heated at 100° C. for five minutes and the substances incorporated therein were uniformly dissolved, followed by cooling, whereby drinks were prepared. The drinks thus prepared were subjected to a sensory test. The results thus obtained are shown in Table 3.

TABLE 3

| | | Example | | | | | | | | |
|---|---|---|---|---|---|---|---|---|---|---|
| | | 5 | 6 | 7 | 8 | 9 | 10 | 11 | 12 | 13 |
| Formulation | Catechin preparation | 0.75 | | | | | | | | |
| (% by mass) | Glutinous rice extract | 13.13 | 26.00 | 39.00 | 51.00 | 64.00 | 78.00 | 35.10 | 24.50 | 17.48 |
| | Cereal extract | — | — | — | — | — | — | — | — | — |
| | Amylose³⁾ | — | — | — | — | — | — | 0.028 | 0.038 | 0.042 |
| | β-cyclodextrin⁴⁾ | — | — | — | — | — | — | — | — | — |
| | Cyclic | — | — | — | — | — | — | — | — | — |
| | oligosaccharides⁵⁾ | | | | | | | | | |
| | Ion-exchanged water | Balance | | | | | | | | |
| | Total | 100 | | | | | | | | |
| Component | (A) Non-polymer | 0.112 | | | | | | | | |
| content | catechins | | | | | | | | | |
| (% by mass) | (D) Starch | 0.16 | 0.31 | 0.47 | 0.61 | 0.77 | 0.94 | 0.45 | 0.33 | 0.25 |
| | (B) Amylopectin | 0.15 | 0.30 | 0.45 | 0.59 | 0.74 | 0.90 | 0.40 | 0.28 | 0.20 |
| | (C) Amylose | 0.01 | 0.01 | 0.02 | 0.02 | 0.03 | 0.04 | 0.04 | 0.05 | 0.05 |
| | Mass ratio (B)/(D) | 96.0 | 96.0 | 96.0 | 96.0 | 96.0 | 96.0 | 90.0 | 85.0 | 80.0 |
| Sensory | Bitterness intensity | 4.0 | 3.0 | 2.5 | 2.5 | 2.5 | 2.0 | 2.5 | 3.2 | 3.5 |
| evaluation | Thickness | 1.0 | 1.0 | 1.0 | 2.0 | 2.0 | 3.0 | 2.4 | 2.4 | 2.4 |

| | | Comparative Example | | | | | | | |
|---|---|---|---|---|---|---|---|---|---|
| | | 5 | 6 | 7 | 8 | 9 | 10 | 11 | 12 |
| Formulation | Catechin preparation | 0.75 | | | | | | | |
| (% by mass) | Glutinous rice extract | 31.20 | 27.30 | — | — | — | — | — | — |
| | Cereal extract | | | — | — | 2.000 | 11.77 | — | — |
| | Amylose³⁾ | 0.048 | 0.065 | — | 0.600 | — | — | — | — |
| | β-cyclodextrin⁴⁾ | — | — | — | — | — | — | 0.750 | — |
| | Cyclic | — | — | — | — | — | — | — | 0.750 |
| | oligosaccharides⁵⁾ | | | | | | | | |
| | Ion-exchanged water | Balance | | | | | | | |
| | Total | 100 | | | | | | | |
| Component | (A) Non-polymer | 0.112 | | | | | | | |
| content | catechins | | | | | | | | |
| (% by mass) | (D) Starch | 0.42 | 0.39 | — | 0.60 | 0.08 | 0.47 | — | — |
| | (B) Amylopectin | 0.36 | 0.31 | — | 0.00 | 0.06 | 0.33 | — | — |
| | (C) Amylose | 0.06 | 0.08 | — | 0.60 | 0.02 | 0.14 | — | — |
| | Mass ratio (B)/(D) | 85.1 | 80.1 | — | 0 | 70.3 | 70.3 | — | — |
| Sensory | Bitterness intensity | 2.5 | 2.5 | 5.0 | 4.9 | 4.5 | 3.0 | 2.0 | 3.0 |
| evaluation | Thickness | 3.4 | 4.0 | 1.0 | 3.0 | 1.0 | 3.0 | 3.6 | 4.0 |

³⁾Amylose (KANTO CHEMICAL CO., INC. amylose 100% by mass)
⁴⁾Celldex B-100 (NMON SHOKUHIN KAKO CO., LTD.)
⁵⁾Celldex SL-20P (NIHON SHOKUHIN KAKO CO., LTD.)

### Examples 14 to 16 and Comparative Example 13

The catechin preparation obtained in Production Example 1, the glutinous rice extract obtained in Production Example 2, and the green tea extract solution obtained in Production Example 4 were incorporated at the ratios as shown in Table 4 to prepare drinks. The drinks thus prepared were subjected to a sensory test. The results thus obtained are shown in Table 4.

TABLE 4

| | | Example | | | Comparative |
|---|---|---|---|---|---|
| | | 14 | 15 | 16 | Example 13 |
| Formulation | Green tea extract | 18.30 | | | |
| (% by mass) | solution | | | | |
| | Catechin preparation | 0.42 | | | |
| | Glutinous rice extract | 13.13 | 39.00 | 78.00 | — |
| | Amylose³⁾ | — | — | — | — |
| | Ion-exchanged water | Balance | | | |
| | Total | 100 | | | |
| Component | (A) Non-polymer catechins | 0.112 | | | |
| content | (D) Starch | 0.156 | 0.465 | 0.929 | — |
| (% by mass) | (B)Amylopectin | 0.150 | 0.446 | 0.892 | — |
| | (C)Amylose | 0.006 | 0.019 | 0.037 | — |
| | Mass ratio (B)/(D) | 96 | 96 | 96 | — |
| Sensory | Bitterness intensity | 4.0 | 2.5 | 2.0 | 5.0 |
| evaluation | Thickness | 1.0 | 1.0 | 3.0 | 1.0 |

³⁾Amylose (KANTO CHEMICAL CO., INC. amylose 100% by mass)

### Examples 17 to 19 and Comparative Example 14

The catechin preparation obtained in Production Example 1, the glutinous rice extract obtained in Production Example 2, and the oolong tea extract solution obtained in Production Example 5 were incorporated at the ratios as shown in Table 5 to prepare drinks. The drinks thus prepared were subjected to a sensory test. The results thus obtained are shown in Table 5.

TABLE 5

| | | Example | | | Comparative |
|---|---|---|---|---|---|
| | | 17 | 18 | 19 | Example 14 |
| Formulation | Oolong tea extract | 17.50 | | | |
| (% by mass) | solution | | | | |
| | Catechin preparation | 0.57 | | | |
| | Glutinous rice extract | 13.13 | 39.00 | 78.00 | — |
| | Amylose³⁾ | — | — | — | — |
| | Ion-exchanged water | Balance | | | |
| | Total | 100 | | | |
| Component | (A) Non-polymer catechins | 0.112 | | | |
| content | (D) Starch | 0.156 | 0.465 | 0.929 | — |
| (% by mass) | (B)Amylopectin | 0.150 | 0.446 | 0.892 | — |
| | (C)Amylose | 0.006 | 0.019 | 0.037 | — |
| | Mass ratio (B)/(D) | 96 | 96 | 96 | — |
| Sensory | Bitterness intensity | 4.0 | 2.5 | 2.0 | 5.0 |
| evaluation | Thickness | 1.0 | 1.0 | 3.0 | 1.0 |

³⁾Amylose (KANTO CHEMICAL CO., INC. amylose 100% by mass)

### Examples 20 to 22 and Comparative Example 15

The catechin preparation obtained in Production Example 1, the glutinous rice extract obtained in Production Example 2, and the black tea extract solution obtained in Production Example 6 were incorporated at the ratios as shown in Table 6 to prepare drinks. The drinks thus prepared were subjected to a sensory test. The results thus obtained are shown in Table 6.

TABLE 6

| | | Example | | | Comparative |
|---|---|---|---|---|---|
| | | 20 | 21 | 22 | Example 15 |
| Formulation | Black tea extract solution | 10.00 | | | |
| (% by mass) | Catechin preparation | 0.70 | | | |
| | Glutinous rice extract | 13.13 | 39.00 | 78.00 | — |
| | Amylose³⁾ | — | — | — | — |
| | Ion-exchanged water | Balance | | | |
| | Total | 100 | | | |
| Component | (A) Non-polymer catechins | 0.112 | | | |
| content | (D) Starch | 0.156 | 0.465 | 0.929 | — |
| (% by mass) | (B)Amylopectin | 0.150 | 0.446 | 0.892 | — |
| | (C)Amylose | 0.006 | 0.019 | 0.037 | — |
| | Mass ratio (B)/(D) | 96 | 96 | 96 | — |
| Sensory | Bitterness intensity | 4.0 | 2.5 | 2.0 | 5.0 |
| evaluation | Thickness | 1.0 | 1.0 | 3.0 | 1.0 |

³⁾Amylose (KANTO CHEMICAL CO., INC. amylose 100% by mass)

From Tables 3 to 6, it was found that unpleasant bitterness was successfully reduced, while thickening was prevented, by controlling the content of each of the non-polymer catechin as the bitter component, amylopectin, and amylose to a predetermined amount.

1-10. (canceled)

11: A method for suppressing bitterness, comprising incorporating amylopectin which is derived from starch having an amylopectin content of 90% by mass or more, in a composition having bitterness.

12: The method for suppressing bitterness according to claim 11, wherein a bitterness intensity of the composition having bitterness is 7 or less based on a quinine sulfate standard solution.

13: The method for suppressing bitterness according to claim 11, comprising incorporating amylopectin in an amount of 0.15% by mass or more relative to a total mass of the composition having bitterness.

14: The method for suppressing bitterness according to claim 11, comprising incorporating amylopectin in an amount of from 0.15 to 2% by mass relative to a total mass of the composition having bitterness.

15: The method for suppressing bitterness according to claim 11, wherein the amylopectin is derived from starch having an amylopectin content of from 90 to 98% by mass.

16: The method for suppressing bitterness according to claim 11, wherein the starch is obtained from at least one selected from the group consisting of glutinous rice and waxy corn.

17: The method for suppressing bitterness according to claim 11, wherein the composition having bitterness is food and drinks having bitterness.

18: The method for suppressing bitterness according to claim 17, wherein the food and drinks having bitterness are a tea.

19: The method for suppressing bitterness according to claim 18, wherein the tea is selected from green tea, black tea and oolong tea.

20: A drink comprising the following components (A), (B), and (C);
(A) a bitter component,
(B) from 0.15 to 0.9% by mass of amylopectin, and
(C) from 0.0001 to 0.05% by mass of amylose.

21: The drink according to claim 20, wherein the (B) amylopectin is derived from starch having an amylopectin content of from 90 to 98% by mass.

22: The drink according to claim 20, wherein the content of the (B) amylopectin is from 0.2 to 0.8% by mass.

23: The drink according to claim 20, wherein the content of the (C) amylose is from 0.001 to 0.04% by mass.

24: The drink according to claim 20, wherein the (A) bitter component is derived from tea.

25: The drink according to claim 24, wherein the tea is selected from green tea, black tea and oolong tea.

26: The drink according to claim 20, wherein the bitter component is polyphenols.

27: The drink according to claim 20, wherein the (A) bitter component is the non-polymer catechins.

28: The drink according to claim 20, wherein the content of the (A) bitter component is an amount such that a bitter intensity of the drink is 7 or less based on a quinine sulfate standard solution.

29: The drink according to claim 20, wherein the (A) bitter component is the non-polymer catechins, and a content of the non-polymer catechins in the drink is from 0.03 to 0.6% by mass.

30: A drink comprising the following components (A), (B), and (C);
(A) from 0.03 to 0.6% by mass of the non-polymer catechins,
(B) from 0.2 to 0.8% by mass of amylopectin, and
(C) from 0.0001 to 0.04% by mass of amylose.
